(19) United States
(12) Patent Application Publication
(10) Pub. No.: US 2003/0097268 A1
(43) Pub. Date: May 22, 2003

(54) System and method for analyzing and evaluation of human behavior stigmata

(75) Inventors: Doron Dinstein, Tel Aviv (IL); Barak Gordon, Rishon Le-Zion (IL); Goren Gordon, Rishon Le-Zion (IL)

Correspondence Address: LYON & LYON LLP, 633 WEST FIFTH STREET, SUITE 4700, LOS ANGELES, CA, 90071, US

(73) Assignee: Magnolia Medical Technologies, Ltd.

(21) Appl. No.: 10/145,575

(22) Filed: May 13, 2002

(30) Foreign Application Priority Data
Nov. 21, 2001 PCT/IL01/01074
Nov. 20, 2001 (IL) 146597

(51) Int. Cl. G10L 21/00

(52) U.S. Cl. 704/275

(57) ABSTRACT

A system and method for analysis and evaluation of audio and video data is disclosed. The method comprises receiving information from an input device; calculating complexity of the information received; calculating indicative parameter of the complexities; and analyzing and converting indicative parameter for final results. The system comprises an input device for capturing information; a computing device for calculating complexities of the captured information, analyzing and converting complexities into indicative parameters, interacting with storage device, user interface and input devices; a storage device for providing the computing device, user interface devices and input devices with storage space; storage of captured, analyzed and converted information; a user interface device for displaying information to the user and interaction of user and system.

### CROSS REFERENCE TO RELATED APPLICATIONS

This application claims priority from PCT Application No. PCT/IL01/01074, filed Jan. 8, 2002, and Israeli Patent Application No. 146597, filed Nov. 20, 2001, each of which is hereby incorporated by reference as if fully set forth herein.

### BACKGROUND OF THE INVENTION

The present invention relates to analysis and summary for the facilitation of relevant data extraction, more specifically the analysis of system and method for analysis and evaluation of human behavior stigmata obtained from various instruments measuring audio and visual output relating to a patient.

Human behavior is a complex form of data output composed of a very large number of audio and visual signs referred here to as Human Behavior Stigmata (HBS). The HBS form part of the human communication tools. A great deal of information regarding the human condition is expressed by verbal as well as non-verbal (visual) form. Much of this information is subconscious and very subtle, such that much information is unused in day to day interactions. Sickness can affect both verbal and visual information emanating from a sick subject. In the field of psychiatry the verbal and visual information extracted from a patient are the only clues for the elucidation of the underlying cause. In psychiatry today, the psychiatric interview is the only tool disposed to the physician for the elucidation of diagnosis.

Up until the twentieth century psychiatric disease was considered outside the medical field, hence no organic brain pathology was found. During the twentieth century advances in cell and molecular biology have led to greater understanding of the microstructure and workings of the brain. The understanding that the core problem of many psychiatric diseases lies with the abnormal function of the brain had “certified” the field. The Diagnostic and Statistical Manual of psychiatric disease (DSM) was developed in order to allow physicians to standardize the psychiatric patients and to define their individual illnesses. Still, even today, the diagnosis of a psychiatric condition and the separation of such disease from other entities is not simple. The reasons for this can include the statistical nature of the DSM, the great disparity in interpretation of symptoms by psychiatrists, the complexity of the human language and behavior which is the core of diagnostic signs and symptoms of the psychiatric illnesses.

A typical psychiatric evaluation is done in an office setting where the patient and the psychiatrist are facing each other seated on chairs or in other similar setting. The psychiatrist observes the patient's behavior stigmata while asking specially directed questions designed to elucidate the psychiatric disturbance. The psychiatrist must note the visuals as well as the audio output emanating from the patient. The visual output can include face mimics and gestures, body movements, habitus and the like. Audio input of importance can include content, fluency, order, vocabulary, and pitch to mention a few. Once the interview is over the physician summarizes the findings and matches them to the minimum requirements suggested by the DSM. In some cases additional exams are required in order to define a psychiatric illness. In some institutes, the psychiatric interview is video taped for the purpose of further analysis.

The human observation capability, though elaborate and complex, is insufficient to fully analyze the enormous wealth of information emanating from the patient and delivered to the physician both as non-verbal and verbal outputs in a relatively short time span. In order to diagnose a psychiatric illness, a great deal of experience is required. In many cases a psychiatric diagnosis will be missed for a relatively long period of time due to the complexity of the task.

Once a psychiatric disease is diagnosed, therapy is initiated. Therapy may include therapeutic chemicals, psychoanalysis, group therapy as well as a myriad of other forms of therapy. The efficacy of therapy is evaluated in repeated psychiatric interviews. Even the most skilled physician may miss small alterations in behavior and appearance that are not readily visible to the human observer, thus misinterpreting the reaction to therapy. Such alterations may be of importance to the medical diagnosis, treatment and prognosis.

There is therefore a need in the art for a fast and more accurate diagnostic and therapeutic evaluation tool of the information contained within the human behavior and appearance.

### SUMMARY OF THE INVENTION

A system and method for analysis and evaluation of audio and video data is disclosed.

The method comprises receiving information from an input device; calculating complexity of the information received; calculating indicative parameter of the complexities; and analyzing and converting indicative parameter for final results.

The system comprises an input device for capturing information; a computing device for calculating complexities of the captured information, analyzing and converting complexities into indicative parameters, interacting with storage device, user interface and input devices; a storage device for providing the computing device, user interface devices and input devices with storage space; storage of captured, analyzed and converted information; a user interface device for displaying information to the user and interaction of user and system.

### BRIEF DESCRIPTION OF THE DRAWINGS

FIG. 1 illustrates parts of the system of the present invention; and

FIG. 2 illustrates operation of the system of the present invention.

### DETAILED DESCRIPTION OF PREFERRED EMBODIMENTS

Preferred embodiments will now be described with reference to the drawings. For clarity of description, any element numeral in one figure will represent the same element if used in any other figure.

The present invention provides for a system and method for analysis and evaluation of Human Behavior Stigmata (HBS) obtained from various instruments measuring audio and visual output emanating from a patient, more specifically video and sound capturing instruments. The system and method can be used for non-invasive diagnosis, prognosis and treatment evaluation. The invention discloses a system and method according to which audio and video complexity calculation can be implemented on audio and video data recordings of human psychiatric patients as well as other subjects for whom the study of behavior patterns is of relevance. The input data is recorded in real-time via audio and video sensitive instruments previously described. The streaming audio and video data is then recorded digitally. The digital recording is received by the application. A complexity calculation of the at least a part of the data is performed. An indicative parameter is calculated using the complexity calculation according to predefined information obtained beforehand. The indicative parameter is used for calculation and transformation such that a final result can be displayed to the user. The final result can point to areas of interest in the HBS stream; facilitate diagnosis, suggest treatment, used as a prognostic marker as well as other forms of medically relevant data. Thus, the output of the system is useful in the evaluation and quantification of behavior, more specifically in Human Behavior Stigmata (HBS), more specifically in the psychiatric disturbances of human behavior.

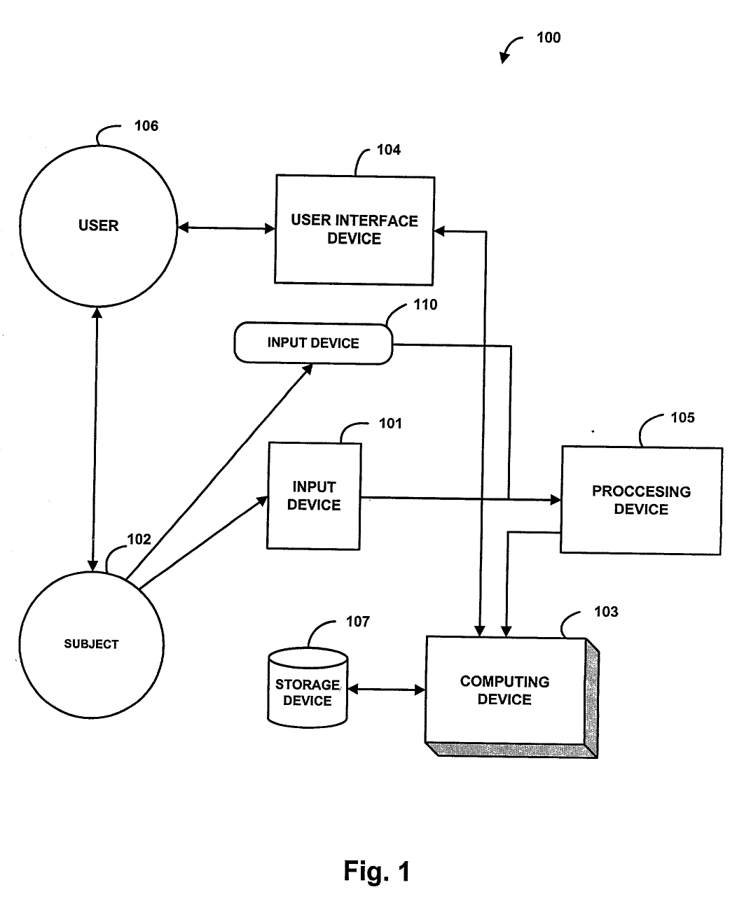

Turning now to FIG. 1 wherein parts of the system of the present invention are disclosed and referenced 100. User 106 is interacting with subject 102. Such interaction is verbal. Input devices 101 and 110 typically directed at subject 102 and situated in such a location as to maximize data location and minimize interaction of user 106 and subject 102 whereby audio and visual data is obtained. Input device 101 is a visual capturing device such as a video camera such as a Sony camcorder, manufactured in Japan, as well as any other instruments capable of capturing streaming visual signals. Input device 110 is an audio capturing device such as a tape recorder such as a Sony tape recorder, a microphone device such as a wireless microphone from Polycome as well as any streaming audio capturing device. In FIG. 1 only two input devices are depicted for the sake of clarity. It will be evident to the person skilled in the art that any number of input devices as well as different types of input devices can be connected to the computing device 103 via processing device 105. Furthermore, it will be appreciated by the person skilled in the art that any device combining an audio as well as video device can be used in place of two input devices 101 and 110 illustrated in FIG. 1. Data obtained by input devices 101 and 110 is transferred via cable, modem, Infra Red (IR) or any other form known to a processing device 105. Analog data obtained by input device 101 and 110 can be transformed into a digital format there within or is transferred preferably to the processing unit 105. Processing unit 105 is functional in converting audio and video data from analog to digital format as well as enhancing and filtering said data as well as transmitting said data to computing device 103 and user 106 via suitable cable, IR apparatus, modem device and similar transfer means of digital information. The parameters used by processing device 105 can be located within the processing device 105, received from user 106 by way of user interface device 104, stored on storage device 107 as well as on other locations outside the proposed system (not shown). It will be evident to the person skilled in the art that many input devices known contain there within processing units such as processing unit 105 such that with many such input devices the existence of processing device 105 in system 100 is optional and input devices 101 and 110 can transfer digital format, enhanced and filtered information directly to computing device 103. Computing device 103 is a software program or a hardware device such as a PC computer, such as a PC computer, hand held computer such as Pocket PC and the like. Within the computing device 103 input received from input devices 101 and 110 is processed and an output data is transferred to the interface devices 104. Interface devices may be a computer screen such as an LG Studioworks 57I, a hand held computer such as Palm Pilot manufactured by the Palm Corporation, a monitor screen, a television device, an interactive LCD screen, a paper record, a speaker device as well as other interface devices functional in conveying video as well as audio information. The output data can be stored on a storage device 107 such as a computer hard disk as well as any storage device. The output data can also be sent for storage, viewing and manipulation to other parties by hard wire (not shown), IR device (not shown) or any other transfer modalities including via data network (not shown). Interface device 104 may be used to alter operation of input devices 101 and 110, computing device 103 or any other part of the system. Such activity can be done by the user 106 via direct human interaction such as by touch, speech, manipulation of attached mouse device and the like. Output information can be viewed as graphs, pictures, audio excerpts, summary analysis, and the like, as well as manipulated by the user 106 for other purposes such as transferring the data, saving the output and the like.

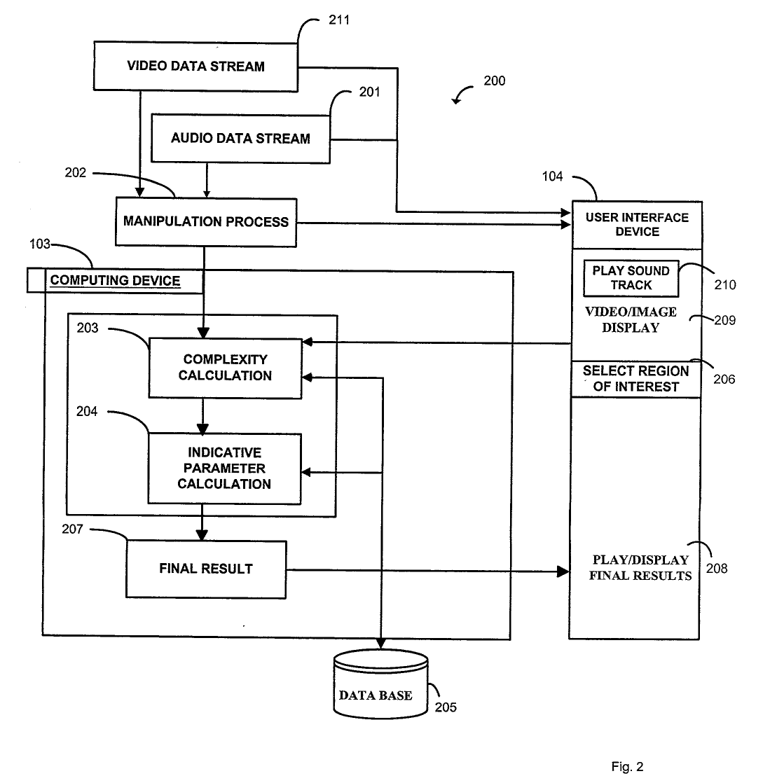

Turning now to FIG. 2 where operation of the system 200 of the present invention is disclosed where an Audio Data Stream (ADS) 201 such as a discussion between user 106 and subject 102 both of FIG. 1 during a psychiatric interview is obtained by input device 110 of FIG. 1. A Video Data Stream (VDS) 211 such as the continuous video of the subject 102 of FIG. 1 during a psychiatric interview is obtained by input device 101 of FIG. 1. The ADS 201 and VDS 211 are optionally transferred by suitable means to the processing device 105 of FIG. 1 where manipulation 202 of the received data is then performed. The manipulations can include amplification, filtering, analog to digital conversion, color correction, and any other manipulations that can be done on audio and video data for the purpose of receiving a pure digitalized audio and video data from the proffered target. Working parameters and a database for the manipulation process 202 are obtained from a predefined data located in processing device 105 of FIG. 1, database 107 as well as directly from user 106 of FIG. 1 as well as through a user interface device 104 also of FIG. 1. It can be easily understood by the person skilled in the art that any of the above mentioned operations can be performed in other locations within the system such as within the computing device 103 also of FIG. 1, as well as in other locations, as well as outside the said system (not shown). Manipulated ADS and VDS are then transferred to the computing device 103 as described also in FIG. 1. Manipulated ADS and VDS then undergo a complexity calculation 203. The complexity calculation 203 performed on the ADS and VDS stream 201 is preferably done on at least one substantially small part of the data. Complexity calculation 203 can be performed automatically as predefined in parameters within the computing device 103 also of FIG. 1, as predefined in data base 205. Said complexity calculation can also be performed on at least one substantially small selected region of interest 206 of said data by user (not shown) using the user interface device 104 also of FIG. 1. Complexities obtained at step 203 can be stored in computing device 103, data base 205 or other appropriate locations in system 200 for further use and reference. Indicative parameter calculation 204 is then calculated from the resulting complexities obtained at step 203. The indicative calculation 204 is a quantitative and qualitative data element, calculated according to the predefined parameters such as previously inputted ADS and VDS streams (i.e. normal mimics, gestures and oration of healthy young adult), predefined formulas describing known and predicted ADS and VDS streams behavior and patterns (i.e. typical body gestures as well as speech of a manic patient etc.) as well as other parameters such as age, social circumstances, racial origin, occupation, previous illnesses, concurrent illnesses and the like. Said data can be stored before hand as well as stored continuously with operation. Said data can then be stored on the Predefined Database 205 as well as on any database device (not shown) connected to the computing device 103 of FIG. 1 as well as any remote databases devices (also not shown). Calculated Indicative Parameter 204 can then be displayed to the user in raw state (not shown) on the user interface device 104 also of FIG. 1. Said parameter can also be saved on the computing device 102 of FIG. 1 as well sent to other computer devices (not shown) by methods known in the art. Calculated Indicative Parameter 204 can then be converted to an easy to understand final result 207 such as an audio and image replay of a part of the interview with enhancement of abnormal findings, a probable diagnosis, an audio and image representation of the findings, such as an exemplary image of a certain gesture, mimic, word use etc., a summary of the streaming ADS and VDS inputs selected, a region of interest of the streaming ADS and VDS by predefined parameters located within the predefined database 205, a suggested therapy indication, a statistical probability of response to therapy and the like. Final result 207 is then transferred to the user interface 104 also of FIG. 1 and is then played and displayed 208 to the user (not shown). The ADS 201 and VDS 211 as well as manipulated ADS done at manipulating process 202 can be directly transferred to the user (not shown) and to the user interface device 104 also of FIG. 1 for observation, supervision as well as for the manipulation of the type, location, as well as other input devices 101 and 110 of FIG. 1 and of the manipulation processes 202. User 106 of FIG. 1 can preferably control all steps of information acquisition, manipulation, viewing, listening, storing, sending and the like.

ADS stream 202 can be played to the user as a sound track 210 as well as displayed as a video or image display 209 during system 200 operation. Thus allowing the user to observe and if needed to manipulate system 200 operation in real time using the user interface device 104 also of FIG. 1 as well as other forms of communication with user interface device 104 as previously discussed.

The person skilled in the art will appreciate that what has been shown is not limited to the description above. Many modifications and other embodiments of the invention will be appreciated by those skilled in the art to which this invention pertains. It will be apparent that the present invention is not limited to the specific embodiments disclosed and those modifications and other embodiments are intended to be included within the scope of the invention. Although specific terms are employed herein, they are used in a generic and descriptive sense only and not for purposes of limitation.

What is claimed is:

1. A method for analysis and evaluation of audio and video data, the method comprising:
receiving information from an input device;
calculating complexity of the information received;
calculating indicative parameter of the complexities;
analyzing and converting indicative parameter for final results.

2. A system for analysis and evaluation of audio and video data, the system comprises:
an input device for capturing information;
a computing device for
calculating complexities of the captured information;
analyzing and converting complexities into indicative parameters;
interacting with storage device, user interface and input devices;
a storage device for
providing computing device, user interface devices and input devices with storage space;
storage of captured, analyzed and converted information;
a user interface device for
displaying information to the user;
interaction of user and system.
